(19) United States
(12) Patent Application Publication
(10) Pub. No.: US 2009/0241432 A1
(43) Pub. Date: Oct. 1, 2009

(54) ABRASIVE MEANS, USE OF ALKALI METAL FLUOROALUMINATES OR ALKALINE EARTH FLUOROALUMINATES FOR STABILIZING POLYMERS AGAINST CHANGE IN COLOR BY THE ACTION OF HEAT, AND MIXTURE CONSISTING OF POTASSIUM TETRAFLUOROALUMINATE AND DIPOTASSIUM PENTAFLUOROALUMINATE AND OF OTHER ABRASIVE-ACTIVE FILLERS

(75) Inventors: Axel Pakusch, Reinhardshagen (DE); Anja Pischtiak, Hannover (DE); Thomas Schwarze, Lehrte (DE)

Correspondence Address: CONNOLLY BOVE LODGE & HUTZ, LLP, P O BOX 2207, WILMINGTON, DE, 19899, US

(73) Assignee: Solvay Fluor GmbH, Hannover (DE)

(21) Appl. No.: 11/909,395

(22) PCT Filed: Mar. 21, 2006
(86) PCT No.: PCT/EP2006/002601

§ 371 Date: Jun. 17, 2008

(30) Foreign Application Priority Data
Mar. 24, 2005 (EP) 05006553.1

(51) Int. Cl. C09K 3/14

(52) U.S. Cl. 51/309

(57) ABSTRACT

The invention relates to an abrasive means with abrasive-active fillers. The abrasive means is comprised, in general, of a support, abrasive grit and of a binder system. In order to improve the abrasive action and the serviceable life of the abrasive means, the binding agent system contains synthetic alkali metal fluoroaluminates, and/or alkaline earth metal fluoroaluminates, in particular, alkali metal tetrafluoroaluminate, preferably potassium tetrafluoroaluminate, together with at least one additional abrasive-active filler.

The invention relates to an abrasive and the use of particular inorganic fluorides as fillers having an abrasive action in abrasives. The invention also relates to the use of particular inorganic fluorides for stabilizing dyes.

It is known that the surfaces of articles, workpieces, components or similar constructions of wood, metal metal alloys, plastic, ceramic, stone or other materials can be smoothed or worked using abrasives.

Abrasives usually comprise the following basic components: the substrate, the abrasive particles and the bonding which is formed with the aid of a binder system.

As abrasive particles, use is made first and foremost of aluminum oxide (corundum), silicon carbide, silicon dioxide such as glass, flint, polycrystalline materials such as fused oxides of zirconium and aluminum or emery. The choice and particle size of the abrasive particles depend on the application. The abrasive particles are fixed to the substrate by means of binders. The binder solidifies and thus fixes the abrasive particle to the substrate. A covering layer, which likewise contains a binder, is usually applied on top of this. The terms base bonding and cover bonding are therefore employed.

The base bonding anchors the abrasive particles to the substrate, i.e. the abrasive particles are bonded to the substrate essentially only via their bottom surface, i.e. directly so that the abrasive particles extend outward with irregular heights and spacings. The covering layer or cover bonding fixes the abrasive particles by filling the intestices between the abrasive particles. The amount applied and thus the layer thickness depends on the size of the abrasive particles.

A distinction is made between two different substrates, namely between flexible and rigid substrates. Flexible substrates used are, for example, satin weaves, fine canvasses, fiber composites, paper or combinations of these materials.

The completely finished abrasives can be used, for example, in the form of continuous tapes, belts or sheets.

The abrasive particles can also be applied to rigid substrates. Abrasives having rigid substrates are, for example, grinding disks, abrasive drills, sharpening stones or parting disks.

A wide range of binders are available for bonding the abrasive particles to the substrate. Binders used are systems which comprise, for example, glues or synthetic resins, e.g. alkyd resins, epoxy resins, urea-formaldehyde resins, preferably phenolic resins. The choice of binder systems can vary and depends on the application for which the abrasives are to be employed. Various auxiliaries, for example pigments, antioxidants, wetting agents or stabilizers, can be added to these binder systems. The range of known auxiliaries is large and likewise depends on the purpose for which the abrasives are to be used.

The abrasives initially have a relatively high cutting performance. However, this decreases during use for various reasons and finally reaches a value at which economical use is no longer ensured and the abrasive therefore has to be discarded. One of the main reasons for the decrease in the cutting performance is that during the grinding of metal, the metal surface exposed during the grinding process is very reactive. These fresh metal surfaces, in particular the metal particles which have been ground off, “weld” to the abrasive material. Oxidation of the exposed surface can also be observed and in this case the metal oxide skin or metal oxide layer formed is generally harder than the unoxidized metal itself. This in turn leads to very high stress on the abrasive particles, associated with an increase in temperature. This is referred to as hot running of the abrasives.

The abrasive particle which projects furthest from the bonding comes into contact with the metal surface to be worked first. If this abrasive particle forms “weld bonds”, increasing frictional forces on the workpiece occur, as a result of which the individual abrasive particle is broken or breaks out. The more often this occurs, the more the grinding surface is worn down and the abrasive particles which do not project so far from the covering layer become effective. The grinding surface thus approaches the support material or the substrate. Finally, complete smudging of the grinding surface occurs. On the other hand, smudging often also occurs even though a considerable proportion of the abrasive particles have not been worn down. Thus, an abrasive can also become unusable before the usability of the abrasive particles themselves is exhausted.

To improve the abrasive action, binder systems containing fillers having an abrasive action, which are, inter alia, intended to prevent welding together, are therefore used for the covering layer. The best-known fillers are simple or complex metal halides such as alkali metal hexafluoroaluminates, for example sodium fluoroaluminate, in particular cryolite, or alkali metal fluoroborates, e.g. potassium fluoroborate (U.S. Pat. No. 3,541,737; U.S. Pat. No. 3,997,302).

It is an object of the invention to provide an abrasive having improved efficiency and thus an increased operating life.

The object is achieved by the abrasive containing, in the binder system, one or more synthetic fluoroaluminates of the general formula MₙAlF_{y}, where M is an alkali metal, n is less than or equal to 2 and y is n+3, or of the general formula Mₙ(AlF_{y})₂, where M is an alkaline earth metal, n is less than or equal to 2 and y is n+3, as filler having an abrasive action and also at least one further filler having an abrasive action.

It is possible for either the pure compounds or mixtures of the compounds with one another to be used and be present in the binder system.

The weight ratio of the fillers having an abrasive action of the above formulae to the firther filler(s) having an abrasive action is preferably in the range from 4:2 to 2:4, particularly preferably in the range from 3:2 to 2:3, very particularly preferably in the range from 2.5:2 to 2:2.5.

For the purposes of the invention, alkali metals are lithium, sodium, potassium, rubidium and cesium, preferably potassium; the preferred alkaline earth metal is calcium. The binder system preferably contains alkali metal tetrafluoroaluminate, in particular potassium tetrafluoroaluminate (KAlF₄), or, as an alternative, mixtures of potassium tetrafluoroaluminate with dipotassium pentafluoroaluminate as filler having an abrasive action of the above formula. In this alternative variant, the abrasive according to the invention preferably contains a mixture of potassium tetrafluoroaluminate (KAlF₄) and dipotassium pentafluoroaluminate (K₂AlF₅) having a melting point in the range from 560 to 572° C., in particular comprising a mixture of potassium tetrafluoroaluminate and potassium pentafluoroaluminate having a melting point in the range from 560 to 572° C., as alkali metal fluoroaluminate and in addition potassium cryolite and/or sodium cryolite and/or potassium tetrafluoroborate and/or potassium fluoride.

A mixture of potassium tetrafluoroaluminate or potassium tetrafluoroaluminate with dipotassium pentafluoroaluminate and other fillers having an abrasive action, e.g. alkali metal hexafluoroaluminate such as sodium cryolite or potassium cryolite, and/or alkali metal tetrafluoroborate such as potassium tetrafluoroborate (KBF₄) and/or metal fluorides, for example potassium fluoride, is likewise provided by the invention. The weight ratio of potassium tetrafluoroaluminate or potassium tetrafluoroaluminate and dipotassium pentafluoroaluminate to the further filler(s) having an abrasive action is preferably in the range from 4:2 to 2:4, particularly preferably in the range from 3:2 to 2:3, very particularly preferably in the range from 2.5:2 to 2:2.5.

The complex metal fluorides are obtained in a known manner, for example by reaction of appropriate aluminum compounds with hydrofluoric acid with addition of appropriate alkali metal or alkaline earth metal fluorides, carbonates or hydroxides.

In the grinding process, about 60% of the cutting energy is converted into heat energy. The incorporation of the fillers having an abrasive action into the base bonding or cover bonding speeds up formation of abrasive material, so that part of the energy which is otherwise lost as a result of friction can be converted into cutting energy.

It has been found that the addition of synthetic alkali metal tetrafluoroaluminate as filler having an abrasive action together with further fillers can improve the cutting performance and the operating life of the abrasives to a greater extent than expected.

In one embodiment of the invention, the abrasive comprises a flexible support material as substrate, an adhesive, in particular a thermoset adhesive, as base and cover binder and also the abrasive particles, with the filler having an abrasive action being able, according to the invention, to be present both in the base bonding and in the cover bonding or only in the cover bonding.

The cover bonding consists essentially of a polymeric, in particular elastomeric, material which adheres well and softens to the desired degree without becoming detached at the relatively high temperatures prevailing during grinding. Such polymers are known. In one embodiment, binder systems whose pH is in the acid range are used. These acid binder systems have the advantage that no serious changes in viscosity occur even on addition of fillers. The binder systems can comprise the polymers together with customary additives such as pigments, dyes, antioxidants, wetting agents or stabilizers. The fillers having an abrasive action, e.g. cryolite or alkali metal fluoroborate, are usually dispersed in the cover bonding.

According to the invention, the synthetic alkali metal and/or alkaline earth metal fluoroaluminates as fillers having an abrasive action are mixed or dispersed in combination with one or more known fillers having an abrasive action into/in the binder system.

In one embodiment of the invention, the fillers having an abrasive action are present both in the base bonding and in the cover bonding.

The cover bonding can be applied as a single layer or in the form of “multibonding” by application of a second covering layer. The second layer can likewise contain the active fillers. The purpose of this “multibonding” is to make the active fillers also available at the points of the abrasive particle in order to be able to utilize their properties at an early point in time during grinding.

The binder compositions for the base bonding and cover bonding can be identical or different. The choice of compositions depends in each case on the purpose for which the abrasives are to be employed.

The amount of binder system to be applied depends on a number of factors, e.g. on the particle size of the abrasive particles, on the amount of abrasive particles applied, i.e. the spacings of the abrasive particles, on the solids content of the binder system, etc. The amount applied should in each case be sufficient for the covering layer to come very close to the surface to be ground during use. It is not desirable for the abrasive particles to be covered completely. This is known to lead to “greasing” on the surface to be worked and thus to little or no removal of material. The points of the abrasive particles have to remain free or be freed. Quite generally, it can be said that a larger amount has to be applied for the covering layer in the case of relatively coarse abrasive particles than in the case of finer abrasive particles. However, the optimum amount of the binder system composition can be determined easily and is not subject matter of the invention.

In one embodiment, the cover bonding contains the filler having an abrasive action in a total amount of not more than 60% by weight, preferably from 4 to 45% by weight, in particular from 10 to 45% by weight, based on the dry weight of the cover bonding. In another embodiment, alkali metal tetrafluoroaluminate, preferably potassium tetrafluoroaluminate, is used as filler having an abrasive action together with at least one further filler having an abrasive action in the total amount mentioned. The amount of filler added depends on the fineness (particle size) of the filler.

A mixture consisting of potassium tetrafluoroaluminate or its mixture with dipotassium pentafluoroaluminate and the known fillers having an abrasive action, e.g. cryolite and/or alkali metal fluoroborate such as potassium fluoroborate and/or metal fluorides, or comprising these, preferably in an amount of at least 85% by weight, is likewise provided by the invention. Preferred weight ratios have been indicated above.

In a preferred embodiment, the total proportion by weight of the inventive fillers having an abrasive action is from 30 to 45% by weight, based on the dry weight of the cover bonding.

In other embodiments, a mixture of synthetic potassium tetrafluoroaluminate and cryolite or potassium tetrafluoroaluminate and potassium tetrafluoroborate in various mixing ratios, for example in a ratio of 50:50, 40:60 or 20:80, is dispersed or incorporated as filler having an abrasive action in the binder system. The mixing ratios can be such that the entire bandwidth is encompassed.

It has been found that a considerable improvement in the grinding performance compared to a covering layer provided only with cryolite as filler having an abrasive action is achieved. The grinding performance could be improved by 20% purely by addition of potassium tetrafluoroalumninate instead of cryolite. When a mixture of potassium tetrafluoroaluminate with cryolite was used, the improvement in the removal of material was 60%. The mixture of potassium tetrafluoroaluminate with potassium tetrafluoroborate led to an increase in the removal of material of virtually 150% compared to an abrasive containing only cryolite as filler having an abrasive action.

The abrasives of the invention are preferably used for the grinding of metal.

It has been found that the addition according to the invention has a positive influence on the flowability and the wettability of the binder system. In addition, when phenolic resin binder systems were used, a positive influence on the interfacial properties was observed. It was likewise observed that when phenolic resin binder systems were used, a stable color matrix could be achieved; in particular, no temperature-dependent color change of the binder system was observed. The invention therefore further provides for the use of alkali metal or alkaline earth metal fluoroaluminates of the formula MₙAlF_{y} or Mₙ(AlF_{y})2, where M, x and y are as defined above, for stabilizing polymers against color changes caused by the action of heat.

A preferred type of use provides for potassium tetrafluoroaluminate or a mixture of potassium tetrafluoroaluminate and dipotassium pentafluoroaluminate to be used, e.g. a mixture of potassium tetrafluoroaluminate and dipotassium pentafluoroaluminate having a melting point of from 560 to 572° C.

The polymers comprise glues or synthetic resins, e.g. alkyd resins, epoxy resins, urea-formaldehyde resins, preferably phenolic resins, or consist thereof.

The glues or synthetic resins are preferably binders for the bonding of abrasive particles.

The following examples illustrate the invention but do not restrict its scope.

### EXAMPLE 1 TO 5

The base binder, a phenolic resin, was applied by means of a rubber roller to the substrate, an impregnated support material comprising woven cotton/PE fabric. The abrasive particles were then applied to the still moist base binder. After drying, the covering layer comprising phenolic resin and additives was applied. As active fillers, potassium tetrafluoroaluminate, cryolite, potassium tetrafluoroborate and mixtures thereof were mixed into the binder system of the covering layer. Metal plates composed of stainless steel ST 37 were ground under standard conditions at a contact pressure of 2.5 bar.

Result:

| Example | Covering layer | Removal of material % |
|---|---|---|
| 1 | No active filler | 100 |
| 2 | Cryolite | 170 |
| 3 | KAlF₄ | 200 |
| 4 | Cryolite/KAlF₄ | 270 |
| | 50:50 | |
| 5 | KalF₄/KBF₄ | 420 |
| | 50:50 | |

The results show a significant improvement in the removal of material. A further advantage of the inventive fillers having an abrasive action is that their addition enables the availability of the abrasives to be greatly increased, i.e. the operating life of the abrasives can be increased.

1-17. (canceled)

18. An abrasive comprising substrate, abrasive particles and bonding, wherein said abrasive comprises one or more synthetic fluoroaluminates of formula MₙAlF_{y} in the binder system, wherein M is an alkali metal, n is less than or equal to 2, and y is n+3, or one or more synthetic fluoroaluminates of formula Mₙ(AlF_{y})₂ as filler having an abrasive action, wherein M is an alkaline earth metal, n is less than or equal to 2, and y is n+3, and at least one additional filler having an abrasive action.

19. The abrasive of claim 18, wherein said bonding is selected from the group consisting of base bonding, cover bonding, and combinations thereof.

20. The abrasive of claim 18, wherein said abrasive comprises an alkali metal fluoroaluminate of formula MₙAlF_{y} and at least one additional filler having an abrasive action in a weight ratio of from 2:3 to 3:2.

21. The abrasive of claim 18, wherein said abrasive comprises an alkali metal tetrafluoroaluminate having an abrasive action in the bonding as filler.

22. The abrasive of claim 18, wherein said bonding comprises alkali metal tetrafluoroaluminate having an abrasive action as filler and one or more additional fillers having an abrasive action selected from the group consisting of alkali metal hexafluoroaluminate, alkali metal fluoroborate, and metal fluorides.

23. The abrasive of claim 22, wherein said alkali metal hexafluoroaluminate is sodium cryolite or potassium cryolite.

24. The abrasive of claim 22, wherein said alkali metal fluoroborate is potassium fluoroborate.

25. The abrasive of claim 22, wherein said metal fluoride is potassium fluoride.

26. The abrasive of claim 18, wherein said abrasive comprises a mixture of potassium tetrafluoroaluminate (KAlF₄) and dipotassium pentafluoroaluminate (K₂AlF₅) having a melting point in the range of from 560 to 572° C.

27. The abrasive of claim 22, wherein said abrasive comprises a mixture of potassium tetrafluoroaluminate and potassium pentafluoroaluminate having a melting point in the range of from 560 to 572° C. and at least one additional compound slected from the group consisting of potassium cryolite, sodium cryolite, potassium tetrafluoroborate, potassium fluoride, and mixtures thereof.

28. The abrasive of claim 18, wherein said bonding comprises synthetic alkali metal or alkaline earth metal fluoroaluminate as filler having an abrasive action and at least one additional filler having an abrasive action in a total amount less than or equal to 60% by weight, based on the dry weight of the bonding.

29. The abrasive of claim 28, wherein said bonding is the cover binder mixture

30. The abrasive of claim 28, wherein said total amount is in the range of from 4 to 45% by weight, based on the dry weight of the bonding.

31. The abrasive of claim 18, wherein said abrasive comprises a flexible substrate.

32. A mixture of potassium tetrafluoroaluminate or potassium tetrafluoroaluminate with dipotassium pentafluoroaluminate and at least one additional fillers having an abrasive action, wherein the weight ratio of the mixture of potassium tetrafluoroaluminate or potassium tetrafluoroaluminate with dipotassium pentafluoroaluminate to said at least one additional filler having an abrasive action is in the range of from 4:2 to 2:4.

33. The mixture of claim 32, wherein said ratio is in the range of from 3:2 to 2:3.

34. The mixture of claim 32, wherein said ratio is in the range of from 2.5:2 to 2:2.5.
